(19) United States
(12) Patent Application Publication
(10) Pub. No.: US 2026/0312096 A1
(43) Pub. Date: Oct. 8, 2026

(54) Fuel Cell System

(71) Applicants: Hyundai Motor Company, Seoul (KR); Kia Corporation, Seoul (KR)

(72) Inventors: Jae Kwan Bae, Seoul (KR); Hae Wook Park, Suwon-Si, Gyeonggi-Do (KR); Seung Man Park, Anyang-Si, Gyeonggi-Do (KR); Ha Neul Lee, Seongnam-Si, Gyeonggi-Do (KR)

(73) Assignees: Hyundai Motor Company, Seoul (KR); Kia Corporation, Seoul (KR)

(21) Appl. No.: 19/182,750

(22) Filed: Apr. 18, 2025

(30) Foreign Application Priority Data
Apr. 22, 2024 (KR) 10-2024-0053508

(51) Int. Cl. H01M 8/04858; H01M 8/04537

(52) U.S. Cl. CPC H01M 8/0494; H01M 8/04559; H01M 2250/20

(57) ABSTRACT

Provided is a fuel cell system including a fuel cell stack configured to include at least one fuel cell, a magnetic field forming portion configured to variably form a magnetic field between an anode and a cathode of at least one fuel cell, and a controller configured to selectively control a direction of the magnetic field between a first direction, oriented from the cathode to the anode, and a second direction, oriented from the anode to the cathode when a magnetic field is formed.

### CROSS-REFERENCE TO RELATED APPLICATION

The present application claims priority of Korean Patent Application No. 10-2024-0053508 filed on Apr. 22, 2024, the entire contents of which are incorporated herein for all purposes by this reference.

### TECHNICAL FIELD

The present disclosure relates to a fuel cell system capable of controlling the electrochemical reactivity and water discharge capability of a fuel cell via a magnetic field.

### BACKGROUND

A fuel cell converts chemical energy into electrical energy by using the oxidation-reduction reaction of hydrogen supplied from a hydrogen supply device and oxygen supplied from an air supply device, for example. The fuel cell may include a fuel cell stack that generates electrical energy and a cooling system for cooling this stack.

Hydrogen may be supplied to the anode of the fuel cell stack, and an oxidation reaction of hydrogen may occur at the anode to generate hydrogen ions (proton) and electrons. These generated hydrogen ions may move to the cathode through an electrolyte membrane, and the generated electrons may move to the cathode through a separator. At the cathode, water may be generated through an electrochemical reaction involving the hydrogen ions and electrons from the anode and oxygen in the air, and electrical energy is generated from the flow of these electrons.

The above electrochemical reaction needs to be controlled according to the state of the fuel cell, control conditions, and/or an operating environment. The discharge of water generated through the electrochemical reaction also needs to be controlled in consideration of various factors.

The above description of the related art is intended to provide a better understanding of the background of the present disclosure and should not be taken as an admission of prior art known to those of ordinary skill in the art.

### SUMMARY

The following summary presents a simplified summary of certain features. The summary is not an extensive overview and is not intended to identify key or critical elements.

Systems, apparatuses, and methods are described for a fuel cell system. A fuel cell system may comprise a fuel cell stack comprising at least one fuel cell, wherein the at least one fuel cell comprises an anode and a cathode; an electromagnet installed on the fuel cell stack and configured to variably form a magnetic field between the anode and the cathode; at least one sensor configured to determine at least one physical characteristic associated with the at least one fuel cell; and a controller circuit configured to selectively control, based on the at least one physical characteristic, the electromagnet to form the magnetic field in a first direction, oriented from the cathode to the anode, or a second direction, oriented from the anode to the cathode.

Also, or alternatively, a fuel cell system may comprise a fuel cell stack comprising at least one fuel cell, wherein the at least one fuel cell comprises an anode and a cathode; an electromagnet configured to variably form a magnetic field between the anode and the cathode; at least one sensor configured to determine at least one physical characteristic associated with the at least one fuel cell; at least one processor; and a memory storing at least one instruction that, when executed by the at least one processor, is configured to cause the fuel cell system to control, based on the at least one physical characteristic, the electromagnet to: form the magnetic field in a changed direction, or change an intensity of the magnetic field.

A method performed by an apparatus of a fuel cell system may comprise receiving, from at least one sensor of the fuel cell system, at least one physical characteristic of a fuel cell stack of the fuel cell system; and controlling, based on the at least one physical characteristic, an electromagnet to form a magnetic field across a fuel cell of the fuel cell stack, wherein at least one of a direction of the magnetic field or an intensity of the magnetic field is set based on the at least one physical characteristic.

These and other features and advantages are described in greater detail below.

### BRIEF DESCRIPTION OF THE DRAWINGS

FIG. 1 is a diagram showing the configuration of a fuel cell system.

FIGS. 2 and 3 are views describing the direction of a magnetic field formed by a magnetic field forming portion in a fuel cell system.

FIGS. 4 to 10 are views describing implementation examples of a magnetic field forming portion.

FIGS. 11 and 12 are flowcharts showing a control process of a fuel cell system performed by a controller.

### DETAILED DESCRIPTION

The specific structural and functional descriptions of examples of the present specification or application disclosed herein are merely illustrative for the purpose of describing examples according to the present disclosure. The examples of the present disclosure may be implemented in various forms and should not be construed as being limited to the examples described in this specification or application.

The examples according to the present disclosure may be subject to various modifications and take on various forms. Therefore, specific examples are illustrated in the drawings and described in detail in this specification or application. However, this is not intended to limit the scope of the present disclosure to the specific forms discussed. The present disclosure should be understood to include all modifications, equivalents, and substitutes encompassed within the spirit and scope of the present disclosure.

Unless otherwise defined, all terms used herein, including technical and scientific terms, have the same meaning as commonly understood by those skill in the art to which the present disclosure pertains. Terms generally defined in commonly used dictionaries should be interpreted as having meanings consistent with the context of the relevant technology and should not be construed in an idealized or overly formal sense unless explicitly defined herein.

Hereinafter, examples disclosed in the present specification will be described in detail with reference to the drawings. The same reference numerals are given to the same or similar components regardless of reference numerals, and a repetitive description thereof will be omitted.

In the description of the following examples, the term “preset” means that the numerical value of a parameter is determined in advance to when the parameter is used in a process and/or algorithm. The numerical value of the parameter may be set prior to and/or when the process or algorithm is started, and/or while the process or algorithm is being performed, depending on the example.

As used in the following description, suffixes “module” and “part” for a component are used or interchangeably used solely for ease of preparation of the specification, and do not have different meanings and each of them does not function by itself.

In describing examples in the present specification, if a detailed description of a known process/feature/component would obscure the gist of the present specification, the detailed description thereof will be omitted herein. In addition, the accompanying drawings are merely for easy understanding of the examples disclosed in the present specification, the technical spirit disclosed in the present specification is not limited by the accompanying drawings, and it should be understood to include all modifications, equivalents, and substitutes included in the spirit and scope of the present disclosure.

Terms including ordinal numbers such as first, second, and the like may be used herein to describe various components, but the various components are not limited by these terms. The terms are used only for the purpose of distinguishing one component from another component.

A component referred to as being “connected” or “coupled” to another component may be directly connected or coupled to the other component or indirectly coupled to the other component, where still another component may be present between the component and the other component. If a component is referred to as being “directly connected” or “directly coupled” to another component, it should be understood that the component is connected or coupled to the other component without any other component present therebetween.

Unless the context clearly dictates otherwise, the singular form includes the plural form.

In the present specification, the terms “comprising,” “having,” “including” or the like are used to specify that a feature, a number, a step, an operation, a component, an element, or a combination thereof described herein exists, and they do not preclude the presence or addition of one or more other features, numbers, steps, operations, components, elements, or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

The term “unit” as used herein may refer to software, or hardware component such as Field-Programmable Gate Array (FPGA), Application Specific Integrated Circuit (ASIC), etc. However, “unit” is not limited to hardware and software. The “unit” may be configured to be stored in an addressable storage medium, or may be configured to execute one or more processors. The “unit” may include components such as software components, object-oriented software components, class components, and task components, as well as processors, functions, attributes, procedures, subroutines, segments of program code, drivers, firmware, microcode, circuits, data, databases, data structures, tables, arrays, and variables. For example, a unit or control unit included in names such as a fuel cell control unit (FCU) is only a term widely used in the naming of a controller that controls the specific function of a vehicle, but does not mean a generic function unit.

A controller may include a communication device for communicating with other control units and/or sensors to control a responsible function, memory for storing an operating system, a logic command, and input/output information, and one or more processors for performing determination, calculation, and decision which are necessary for controlling the responsible function. A controller may include, for example, a processor, a central processing unit (CPU), a microchip, a logic, an application-specific integrated circuit (ASIC), memory, etc. A controller may manipulate and/or control other components in the system (e.g., vehicle).

A fuel cell system according to an example of the present disclosure is provided to allow a magnetic field to be variably formed between an anode and cathode of a fuel cell, thereby controlling the electrochemical reactivity and water discharge of the fuel cell.

Before describing a control process of a fuel cell system according to an example of the present disclosure, the configuration of the fuel cell system will first be described below.

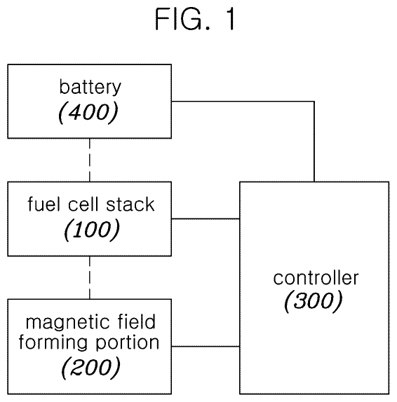

FIG. 1 is a diagram showing the configuration of a fuel cell system.

Referring to FIG. 1, a fuel cell system may include a fuel cell stack 100, a magnetic field forming portion 200, a controller 300, and a battery 400. However, FIG. 1 primarily shows the components related to the description of an example of the present disclosure, and an actual fuel cell system may be implemented with more or fewer components than those described. For example, depending on examples, the battery 400 may not be included in the fuel cell system and may be implemented as a separate component connected to the fuel cell system. For example, the fuel cell system disclosed herein may comprise a one or more sensors, such as one or more of temperature sensors, pressure sensors, level sensors, flow sensors, electrical circuit sensors, and/or proximity sensors. The electrical circuit sensors may comprise one or more voltage sensors, one or more current sensors, and/or one or more impedance sensors (e.g., an electrical resistance sensor). The electrical circuit sensors may measure a voltage deviation and or a voltage difference described herein (e.g., a difference between an average cell voltage and a minimum cell voltage of the fuel cell stack). Hereinafter, each component will be described.

The fuel cell stack 100 may generate power by converting chemical energy into electrical energy through/via an electrochemical reaction comprising the oxidation-reduction reaction of supplied hydrogen and oxygen. To this end, the fuel cell stack 100 may include at least one fuel cell having an anode and a cathode. An electrolyte membrane may be provided between the anode and the cathode in the fuel cell.

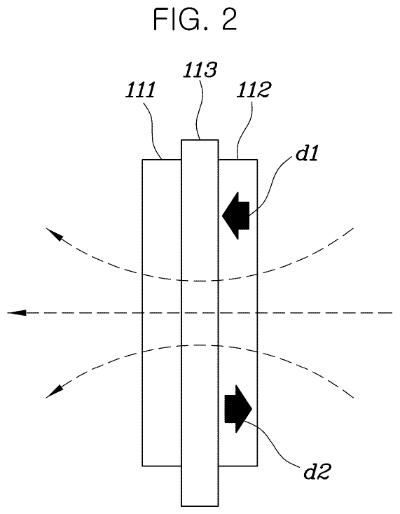

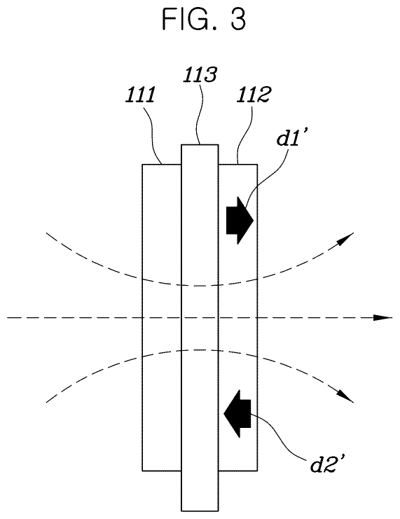

The magnetic field forming portion 200 (e.g., comprising one or more electromagnets or any other types of magnets) may be installed on the fuel cell stack 100 and may variably form a magnetic field between the anode and cathode of at least one fuel cell. The magnetic field forming portion 200 may, for example, be implemented as one or more electromagnets installed on the fuel cell stack 100. The magnetic field formed by the magnetic field forming portion 200 and the effect of the magnetic field on the electrochemical reaction and water discharge will be described below with reference to FIGS. 2 and 3.

FIGS. 2 and 3 are views to facilitate describing the direction of a magnetic field formed by a magnetic field forming portion 200 in a fuel cell system according to examples of the present disclosure.

Referring to FIGS. 2 and 3, the direction of the magnetic field formed by the magnetic field forming portion 200 according to an example of the present disclosure is shown in the form of magnetic field lines (dashed lines with arrows—e.g., lines of magnetic force).

FIG. 2 shows a case where the direction of the magnetic field is a first direction (e.g., oriented from a cathode 112 toward an anode 111, a direction that mitigates a flooding state, etc.). FIG. 3 shows a case where the direction of the magnetic field is a second direction (e.g., oriented from the anode 111 toward the cathode 112, a direction that mitigates a dry-out state, etc.). Depending on the direction of the magnetic field as described herein, the electrochemical reaction and water discharge of the fuel cell may be promoted or suppressed.

For example, the magnetic field formed by the magnetic field forming portion 200 may exert a force on oxygen and water molecules inside a fuel cell 110. The force exerted may follow equation I below, thereby enabling the control of the movement of oxygen and water molecules.

$${F}_{m} = \frac{x}{{u}_{0}} B ∇ B \qquad ( I )$$

In this case, Fₘ is the force exerted on oxygen or water molecules by the magnetic field \vec{B}, x is the magnetic susceptibility of oxygen or water molecules, u₀ is the permeability in free space, and B is the intensity of the magnetic field (magnetic field density).

In addition, in the case that the magnetic field forming portion 200 comprises an electromagnet comprising a wire wound in a coil, the intensity of the magnetic field may be expressed by the following equation II:

$$B = \frac{N \times I}{\frac{{L}_{core}}{μ} + \frac{{L}_{g a p}}{μ 0}} \qquad ( II )$$

In this case, B is the intensity of the magnetic field, N is the number of windings, I is the current applied to the windings, L_{core} is the length of the electromagnet, μ is the permeability of the electromagnet, L_{gap} is the distance from the electromagnet, and μ₀ is the permeability in free space.

The electrochemical reaction may be promoted or suppressed depending on the force exerted on oxygen molecules. Without limiting to theory, this may be because the force exerted on the oxygen molecules by the magnetic field alters the partial pressure of oxygen in the electrochemical reaction area within the fuel cell 110. Altering the partial pressure of the oxygen may change the exchange current density. The relationship between the oxygen partial pressure and the exchange current density may be expressed by the following equation III.

$${i}_{0} = {i}_{0}^{ref} {a}_{c} {{L}_{c} ( \frac{{P}_{r}}{{P}_{r}^{ref}} )}^{γ} exp [ - \frac{{E}_{c}}{R T} ( 1 - \frac{T}{{T}_{ref}} ) ] \qquad ( III )$$

In this case, i₀ is the exchange current density,

$${i}_{0}^{ref}$$

is the target value of the exchange current density, a_{c} is the specific surface area of the catalyst, L_{c} is the catalyst loading amount per unit volume, Pᵣ is the reactant partial pressure,

$${P}_{r}^{ref}$$

is the target value of the reactant partial pressure, R is the gas constant, T is the temperature, T_{ref} is the target value of the temperature, E_{c} is the activation energy, and γ is the pressure coefficient. For example, as shown in FIG. 2, if the direction of the magnetic field is oriented in the first direction (e.g., from the cathode 112 toward the anode 111, a direction that mitigates a flooding state, etc.), a movement d1 of the paramagnetic oxygen molecules in the cathode 112 may be induced by the magnetic force in a direction from the cathode 112 toward the anode 111. The influx of oxygen toward the three-phase interface of the cathode 112, where the electrochemical reaction occurs, may be increased, thereby promoting the electrochemical reaction.

As shown in FIG. 3, if the direction of the magnetic field is oriented in the second direction (e.g., from the anode 111 toward the cathode 112, a direction that mitigates a dry-out state, etc.), a movement d1′ of the paramagnetic oxygen molecules in the cathode 112 may be induced by the magnetic force in a direction from the anode 111 toward the cathode 112. For example, the influx of oxygen toward the three-phase interface of the cathode 112, where the electrochemical reaction occurs, may be decreased, thereby suppressing the electrochemical reaction.

Since water molecules are diamagnetic, unlike oxygen molecules, water molecules may be induced in the opposite direction under the same magnetic field that induces motion of the oxygen molecules in the first direction or the second direction, respectively. For example, as shown in FIG. 2, if the direction of the magnetic field is oriented in the first direction from the cathode 112 toward the anode 111, a movement d2 of the water molecules in the cathode 112 may be induced by the magnetic force in a direction from the anode 111 toward the cathode 112. For example, water may move more or faster toward the outside of the cathode 112 where water discharge occurs, thereby promoting water discharge.

As shown in FIG. 3, if the direction of the magnetic field is oriented in the second direction from the anode 111 toward the cathode 112, a movement d2′ of the water molecules in the cathode 112 may be induced by the magnetic force in a direction from the cathode 112 toward the anode 111. For example, the movement of water toward the outside of the cathode 112, where water discharge occurs, is weakened/reduced, thereby suppressing water discharge.

If the direction of the magnetic field is oriented in the first direction, the electrochemical reaction and water discharge may be promoted. If the direction of the magnetic field is oriented in the second direction, the electrochemical reaction and water discharge may be suppressed. Therefore, controlling the magnetic field direction to the first direction may be referred to as promotion control, and controlling the magnetic field direction to the second direction may be referred to as suppression control.

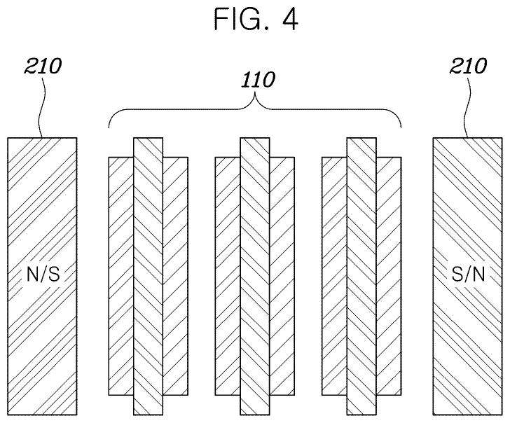

The specific structure of the magnetic field forming portion 200 for forming the magnetic field as described above will be described below with reference to FIGS. 4 to 10.

FIGS. 4 to 10 are views to facilitate describing implementation examples of a magnetic field forming portion 200 according to examples of the present disclosure. FIGS. 4 to 10 are merely provided to describe the examples of the present disclosure, and the magnetic field forming portion 200 may be implemented in various structures and configurations that may variably/controllably form a magnetic field between the anode 111 and the cathode 112 of the fuel cell 110.

FIG. 4 shows an example in which the magnetic field forming portion 200 is provided on the two sides of a plurality of fuel cells 110.

Referring to FIG. 4, the magnetic field forming portion 200 may be implemented to include a plurality of electromagnets 210 arranged parallel to the two sides of the plurality of fuel cells 110, along the direction in which the plurality of fuel cells 110 are arrayed. The polarity of the electromagnets 210 on the two sides may be variably controlled. The polarity of the electromagnets 210 on the two sides of the fuel cells 110 may be controlled to be opposite to each other, so as to generate a magnetic field. Also, or alternatively, the electromagnets 210 on the two sides may be controlled to have no polarity, in which case no magnetic field is formed. To variably form the magnetic field in this manner, the controller 300 may control a current applied to the electromagnets 210.

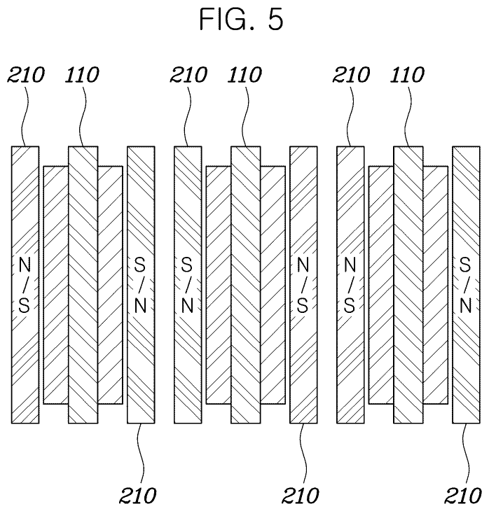

FIG. 5 shows an example in which the magnetic field forming portion 200 is provided as a plurality of electromagnet pairs that each correspond to a different fuel cell 110.

Referring to FIG. 5, the magnetic field forming portion 200 may include a plurality of electromagnets 210 arranged parallel to an anode 111 and a cathode 112 of each fuel cell 110. The polarity of the electromagnets 210 corresponding to each fuel cell 110 may be variably controlled (e.g., independently of each other and/or of electromagnets corresponding to other fuel cells 110). The polarity of the electromagnets 210 on both sides of a corresponding fuel cell may be controlled to be opposite to each other, so as to form a magnetic field across the corresponding fuel cell. Also, or alternatively, the electromagnets 210 on both sides may be controlled to have no polarity, in which case no magnetic field may be formed. To variably form the magnetic field in this manner, the controller 300 may control the current applied to the electromagnets 210. Compared to the example of implementation shown in FIG. 4, if the magnetic field forming portion 200 is provided as shown in FIG. 5, it is possible to control the electrochemical reaction and water discharge through the magnetic field for each fuel cell 110 (e.g., independently).

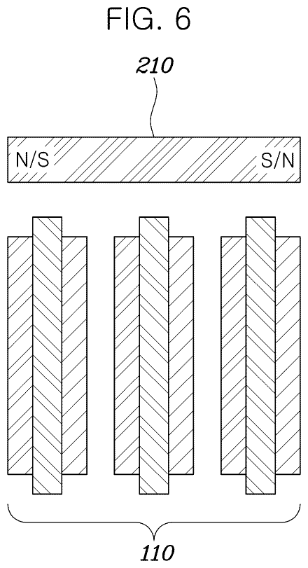

FIG. 6 shows an example in which the magnetic field forming portion 200 is implemented using an electromagnet 210 arranged perpendicularly to the fuel cells 110.

Referring to FIG. 6, the magnetic field forming portion 200 may be implemented to include the electromagnet 210 arranged in a direction perpendicular to the direction of the arrangement of the fuel cells 110. The electromagnet 210 may comprise/be controlled to have both polarities. The polarity of the electromagnet 210 may be variably controlled. Both ends of the electromagnet 210 may be controlled to have opposite polarities to form a magnetic field. Also, or alternatively, the electromagnet 210 may be controlled to have no polarity, thereby forming no magnetic field. To variably form the magnetic field in this manner, the controller 300 may control the current applied to the electromagnet 210.

The magnetic field forming portion 200 according to other examples of the present disclosure may be implemented in various forms. For example, a plurality of electromagnets 210 with both polarities may be arranged on both sides of the fuel cells 110 (e.g., above and below in the drawing of FIG. 6) along a direction perpendicular to the arrangement direction of the fuel cells 110. Also, or alternatively, a plurality of electromagnets 210, arranged parallel and/or perpendicular to the fuel cells 110, may enclose three or four sides of the fuel cells 110 (e.g., of each fuel cell 110 individual and/or of one or more groups of fuel cells 110, etc.).

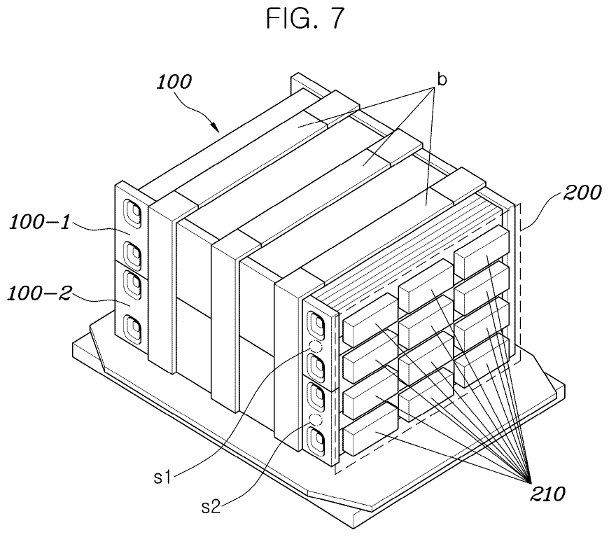

FIGS. 7 to 10 show examples illustrating an arrangement/a method of installing the magnetic field forming portion 200 on the fuel cell stack 100.

Referring to FIGS. 7 to 10, the fuel cell stack 100 may be provided with a plurality of fuel cells 110 arranged in a direction from the lower-left corner to the upper-right corner of the drawing (or in the opposite direction).

The fuel cell stack 100 may also, or alternatively, be implemented to include a first sub-stack 100-1, which may include parts of the plurality of fuel cells 110 that constitute the fuel cell stack 100, and a second sub-stack 100-2, which may include additional and/or remaining parts of the fuel cells. For example, the first sub-stack 100-1 may be referred to as an upper sub-stack, and the second sub-stack 100-2 may be referred to as a lower sub-stack.

The first sub-stack 100-1 and the second sub-stack 100-2 may be independently supplied with fuel (hydrogen), air, and/or coolant. The first sub-stack 100-1 and the second sub-stack 100-2 may be equipped with temperature sensors s1 and s2 (e.g., at a coolant outlet, from which coolant, having exchanged heat with the respective sub-stack, may be discharged). In this case, the controller 300 may control the magnetic field(s) based on the temperatures from temperature sensors s1 and/or s2 (e.g., may use the temperatures, detected by the temperature sensors s1 and s2, as indicators of the temperatures of the first sub-stack 100-1 and the second sub-stack 100-2). One or more voltage sensors may be configured to measure individual cell voltages and/or cell stack voltages (voltages of first sub-stack 100-1 and/or second sub-stack 100-2, and/or of the fuel cell stack 100). the controller 300 may also, or alternatively, be configured to control the magnetic fields based on one or more voltages measured by the one or more voltage sensors.

The first sub-stack 100-1 and/or the second sub-stack 100-2 may be pressed and/or secured in a stacked state using a fastening (e.g., fastening band b in FIG. 7).

Based on the structure of the fuel cell stack 100 as described above, referring to FIG. 7, the magnetic field forming portion 200 according to an example may be implemented using a plurality of electromagnets 210 installed on one side of the fuel cell stack 100. Although not illustrated in the drawing, the plurality of electromagnets 210 may also be installed on the opposite side of the fuel cell stack 100, and furthermore, may be installed inside the fuel cell stack 100 (e.g., between fuel cells 110 of the fuel cell stack).

The plurality of electromagnets 210 may each be configured to form a magnetic field and be individually controlled. Depending on the combination of individual controls for each electromagnet, a magnetic field may be formed/controlled in various ways in the fuel cell stack 100.

For example, some of the plurality of electromagnets 210 may be controlled to form a magnetic field while others may be controlled to not form a magnetic field. A direction and/or intensity of the magnetic field formed by all or some of the electromagnets 210 may vary/be controlled.

For example, among the plurality of electromagnets 210 shown in FIG. 7, only electromagnets 210′ arranged to correspond to a specific portion of the fuel cell stack 100 may be controlled to form a magnetic field, while the other electromagnets may be controlled to not form a magnetic field, thereby allowing a magnetic field to be formed intensively/concentrated in a specific portion of the fuel cell stack 100. Therefore, if an imbalance occurs due to/of abnormal cell voltage (e.g., determined and/or received from the one or more voltage sensors) and/or temperature (e.g., determined by and/or received from one or more temperature sensors, e.g., sensors s1 and s2) in a specific portion of the fuel cell stack 100, the imbalance may be resolved by promoting or suppressing the electrochemical reaction through the magnetic field formed intensively in that portion.

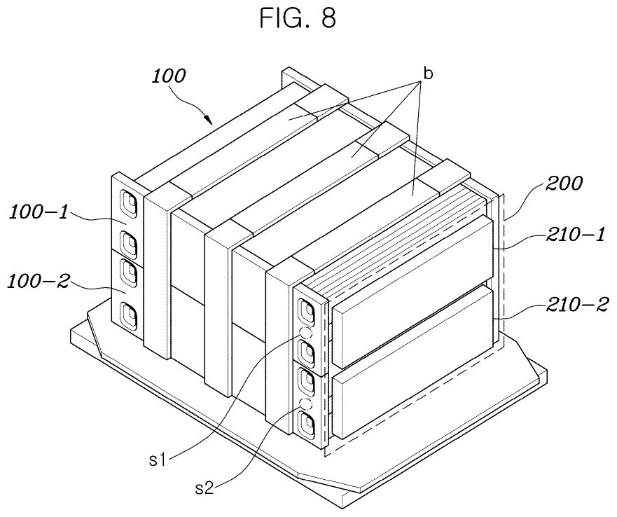

Referring to FIG. 8, the magnetic field forming portion 200 according to an example may be implemented using a first electromagnet 210-1 and/or a second electromagnet 210-2 corresponding to the first sub-stack 100-1 and/or the second sub-stack 100-2, respectively. The first electromagnet 210-1 may form a magnetic field for the first sub-stack 100-1, thereby affecting the electrochemical reaction and water discharge of the first sub-stack 100-1. The second electromagnet 210-2 may form a magnetic field for the second sub-stack 100-2, thereby affecting the electrochemical reaction and water discharge of the second sub-stack 100-2. Therefore, the magnetic field forming portion 200, implemented using the first electromagnet 210-1 and the second electromagnet 210-2, may allow independent control of the electrochemical reactions and water discharge in/of the first sub-stack 100-1 and/or the second sub-stack 100-2.

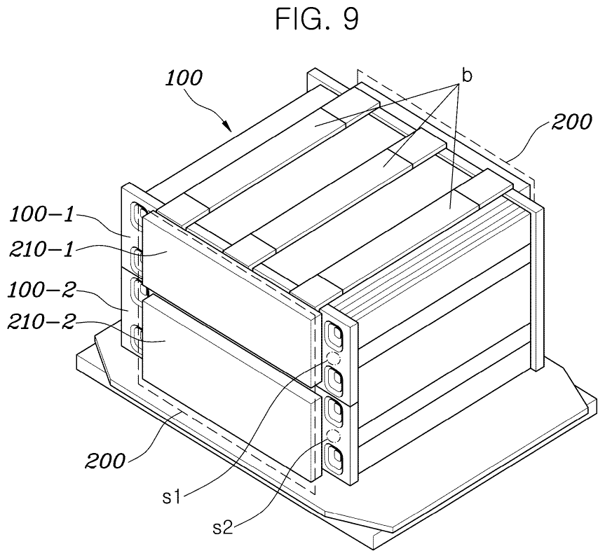

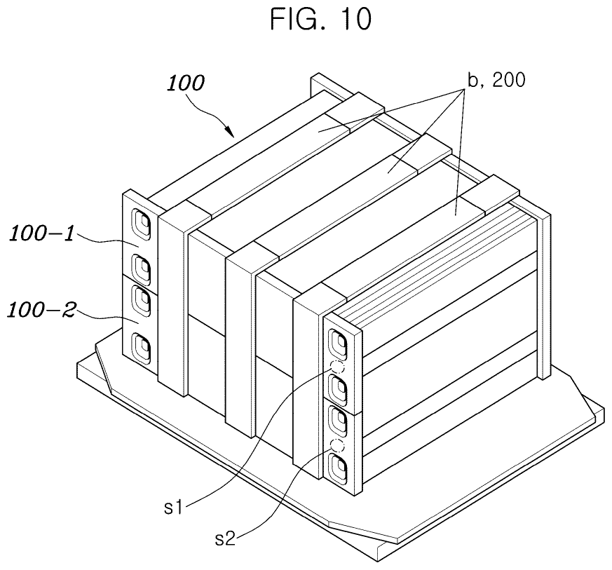

Referring to FIG. 9, the magnetic field forming portion 200 may be installed on the fuel cell stack 100 parallel to the arrangement direction of the fuel cells 110 and/or on both sides of the fuel cell stack 100. Also, or alternatively, referring to FIG. 10, the magnetic field forming portion 200 may be provided inside the fastening band b.

The electromagnets 210 of the magnetic field forming portion 200 may have a plate-like shape, such as shown in FIGS. 7 to 10. However, electromagnets 210 are not limited to this shape, and various forms of electromagnets 210, such as coil types, may be used in the magnetic field forming portion 200. Also, or alternatively, as described herein, the electromagnet 210 may be implemented as a unipolar or a bipolar.

Referring to FIG. 1, for example, magnetic field variable control performed by the controller 300 of the fuel cell system will be described below based on the configuration and structure of the fuel cell system described herein.

The controller 300 may selectively controls the magnetic field forming portion 200 to form a magnetic field. For example, the controller may control the magnetic field forming portion 200 to form the magnetic field in one of the first direction, oriented from the cathode 112 to the anode 111, or the second direction, oriented from the anode 111 to the cathode 112. The controller 300 may variably control the intensity of the formed magnetic field. The electrochemical reaction and water discharge of the fuel cell may be controlled based on the direction and/or intensity of the magnetic field.

The controller 300 may control a power supply to/of the magnetic field forming portion 200, thereby controlling formation of the magnetic field via/by the magnetic field forming portion 200. For example, controlling the power supply may allow for controlling the direction and/or intensity of the magnetic field. The controller 300 may cause power stored in the battery 400 to be supplied to the magnetic field forming portion 200 and/or the power generated by the fuel cell stack 100 to be supplied to the magnetic field forming portion 200. This supplied power may result in forming the magnetic field via/by the magnetic field forming portion 200. Controlling formation of the magnetic field may comprise controlling the direction and/or intensity of the formed magnetic field. The power source for supplying power to the magnetic field forming portion 200 may be implemented in various ways, such as via a separate auxiliary battery provided in/associated with the fuel cell system.

The controller 300 may control the direction of the magnetic field based on at least one of the following: a charge level of the battery 400 connected to the fuel cell stack 100 and/or the required/desired/target output for the fuel cell stack 100. The controller 300 may control the direction of the magnetic field based on the charge level of the battery 400, or based on the required/desired/target output of the fuel cell stack 100, and may also control the direction of the magnetic field by considering both factors.

For example, a State of Charge (SOC) (e.g., in percentage (%)) may be used as an indicator of the charge level of the battery 400. The controller 300 may control the direction of the magnetic field to the first direction based on the charge level of the battery 400 satisfying (e.g., being equal to or below) a preset lower charge threshold. The lower charge threshold may serve as a criterion for initiating control to reduce overdischarge of the battery 400. For example, the lower charge threshold may be set to 35% and/or the threshold value may vary depending on the specifications of the fuel cell stack 100 and/or the battery 400 used in the fuel cell system. If the charge level of the battery 400 satisfies (e.g., is below) the lower charge threshold, controlling the direction of the magnetic field to the first direction may promote the electrochemical reaction of the fuel cell, thereby increasing the power generation of the fuel cell stack 100. The charge level may increase, based on charging by the power generated. Consequently, the overdischarge of the battery 400 may be reduced, such as by shortening the duration during which the charge level of the battery 400 remains below the lower charge threshold.

Also, or alternatively, the controller 300 may control the direction of the magnetic field to the second direction based on the charge level of the battery 400 satisfying (e.g., equaling and/or exceeding) a preset upper charge threshold. The upper charge threshold may serve as a criterion for initiating control to reduce overcharge of the battery 400. For example, the upper charge threshold may be set to 80%, but the threshold value may vary/be varied depending on the specifications of the fuel cell stack 100 and the battery 400 used in the fuel cell system. As such, if the charge level of the battery 400 satisfies (e.g., meets or exceeds) the upper charge threshold, controlling the direction of the magnetic field to the second direction may suppress the electrochemical reaction of the fuel cell, thereby decreasing the power generation of the fuel cell stack 100. The charge level of the battery 400, charged by the power generated, may thereby decrease. Consequently, overcharge of the battery 400 may be reduced, such as by shortening the duration during which the charge level of the battery 400 remains above the upper charge threshold.

Also, or alternatively, the controller 300 may control the direction of the magnetic field formed by/via the magnetic field forming portion 200, based on the required/desired/target output of the fuel cell stack 100. The required/desired/target output may refer to the target output level (power amount) of the fuel cell stack 100, for example.

For example, the controller 300 may control the direction of the magnetic field based on the amount of change per unit time in the required output. If the amount of change per unit time in the required output satisfies (e.g. meets or exceeds) a preset increase threshold for the change amount, the controller 300 may control the direction of the magnetic field to the first direction. In this case, the increase threshold for the change amount may serve as a criterion for determining whether there is a rapid increase in the required output, the increase threshold may be set as a positive value for effecting a serving as a criterion for detecting an increase (e.g., rapid increase) in the required output. The specific value may vary/be varied depending on the specifications of the fuel cell stack 100 used in the fuel cell system.

If the amount of change per unit time in the required output satisfies (e.g., meets and/or exceeds) the preset increase threshold for the change amount, controlling the direction of the magnetic field to the first direction may improve the output performance of the fuel cell stack 100 by promoting the electrochemical reaction of the fuel cell in a situation where the required output increases rapidly.

Also, or alternatively, the controller 300 may control the direction of the magnetic field based on the voltage of the stack 100 and an upper voltage threshold. The controller 300 may control the direction of the magnetic field based on the voltage of the stack 100 if the amount of change per unit time in the required output satisfied (is equal to or below) a preset decrease threshold for the change amount. The decrease threshold for the change amount may serve as a criterion for determining whether there is a rapid decrease in the required output. The decrease threshold may be set as a negative value for serving as a criterion for determining whether there is a rapid decrease in the required output. The specific value may vary/ve varied depending on the specifications of the fuel cell stack 100 used in the fuel cell system, for example. Also, or alternatively, the upper voltage threshold may be set for protection and/or reliable operation of the fuel cell stack 100. The voltage of the fuel cell stack 100 may be limited depending on/via the upper voltage threshold. For example, the controller 300 may control the direction of the magnetic field to the second direction if the amount of change per unit time in the required output satisfies (e.g., is equal to or below) the decrease threshold for the change amount, and the voltage of the stack 100 satisfies (e.g., is equal to or exceeds) the upper voltage threshold.

If the amount of change per unit time in the required output satisfies (e.g., is equal to or below) the preset decrease threshold for the change amount and the upper voltage threshold is reached and/or exceeded, controlling the direction of the magnetic field to the second direction may allow the voltage of the fuel cell stack 100 to be reduced (e.g., by suppressing the electrochemical reaction of the fuel cell. Reducing the voltage may resolve the state in which the voltage of the stack 100 meets or exceeds the upper voltage threshold. If the charge level of the battery 400 satisfies (e.g., is higher than or equal to) the preset lower charge threshold and lower than or equal to the preset upper charge threshold, the controller 300 may control the direction of the magnetic field based on the moisture state of the fuel cell stack. The moisture state may be one of a flooding state or a dry-out state. Also, or alternatively, if the amount of change per unit time in the required output satisfies (e.g., is equal to or below) the decrease threshold for the change amount and the voltage of the stack 100 satisfies (e.g., is lower than or equal to the upper voltage threshold), the controller 300 may control the direction of the magnetic field based on the moisture state of the fuel cell stack 100 (e.g., such as the dry-out state and the flooding state).

The flooding state may be understood as a state where water generated by the electrochemical reaction is not properly discharged to the outside, hindering the diffusion of the fuel (hydrogen). The dry-out state may be understood as a state where low humidity within the fuel cell causes a slowdown in the movement of ions and electrons.

The controller 300 may control the direction of the magnetic field to the second direction based on the moisture state of the fuel cell stack 100 being in the dry-out state. The electrochemical reaction may be suppressed, and/or the discharge of water generated by the electrochemical reaction may also suppressed, which may assist in resolving the dry-out state.

Also, or alternatively the controller 300 may control the direction of the magnetic field to the first direction based on the moisture state of the fuel cell stack 100 being in the flooding state. The electrochemical reaction may be promoted. The discharge of water generated by the electrochemical reaction may also or alternatively be promoted. The promotion of the electrochemical reaction and discharge of the water may assist in resolving the flooding state.

The controller 300 may independently control the magnetic field formed by the magnetic field forming portion 200 on a sub-stack basis. For example, if the fuel cell stack 100 includes the first sub-stack 100-1 that includes parts of the fuel cells 110 and the second sub-stack 100-2 that includes another part (e.g., a remaining part) of the fuel cells, the controller 300 may independently control magnetic fields to be formed for each fuel cell 110 in the first sub-stack 100-1 and/or the second sub-stack 100-2 via/by the magnetic field forming portion 200. Furthermore, the fuel cell stack 100 may include additional sub-stacks in addition to the first sub-stack 100-1 and the second sub-stack 100-2. In such cases, the controller 300 may independently control the magnetic field for each sub-stack.

To control the magnetic field for each sub-stack in the fuel cell stack 100, the controller 300 may control the direction of the magnetic field for the first sub-stack 100-1 and the second sub-stack 100-2 based on a temperature difference between the first sub-stack 100-1 and the second sub-stack 100-2, for example.

For example, if the temperature difference between the first sub-stack 100-1 and the second sub-stack 100-2 exceeds a preset reference temperature difference, the controller 300 may control the direction of the magnetic field for the first sub-stack 100-1 and/or the second sub-stack 100-2. For example, the temperature difference and the reference temperature difference between the first sub-stack 100-1 and the second sub-stack 100-2 may serve as indicators for determining imbalance between the sub-stacks (e.g., temperature imbalance). The reference temperature difference may be set, for example, at 2° C., but the value thereof may vary/be varied depending on the specifications of the fuel cell system.

For example, if the temperature difference between the first sub-stack 100-1 and the second sub-stack 100-2 exceeds the preset reference temperature difference, and the moisture state of the fuel cell stack 100 is in the dry-out state, the controller 300 may control the magnetic field to be in the second direction for the relatively low-temperature sub-stack between the first sub-stack 100-1 and the second sub-stack 100-2.

For example, the electrochemical reaction of the relatively low-temperature sub-stack may be suppressed, and water discharge of the relatively low-temperature sub-stack may be suppressed, thereby preventing the worsening of the dry-out state. Also, or alternatively, the oxygen inflow to the cathode may be reduced, which may increase the mass transfer resistance of the relatively low-temperature sub-stack, which in turn may increase the heat generation of the relatively low-temperature sub-stack, thereby reducing the temperature difference between the sub-stacks.

Also, or alternatively, if the temperature difference between the first sub-stack 100-1 and the second sub-stack 100-2 satisfies (e.g., exceeds or equals) the preset reference temperature difference, and the moisture state of the fuel cell stack 100 is in the flooding state, the controller 300 may control the magnetic field to be in the first direction for the relatively high-temperature sub-stack between the first sub-stack 100-1 and the second sub-stack 100-2.

For example, the electrochemical reaction of the relatively high-temperature sub-stack may be promoted, and water discharge of the relatively high-temperature sub-stack may be promoted, thereby preventing the worsening of the flooding state. Also, or alternatively, the oxygen inflow to the cathode may be increased, which may reduce the mass transfer resistance of the relatively high-temperature sub-stack, which in turn may decrease the heat generation of the relatively high-temperature sub-stack, thereby reducing the temperature difference between the sub-stacks.

As such, controlling the magnetic field of each sub-stack (e.g., independently/differently) based on the temperature difference between the sub-stacks may enable the prevention of an increase in voltage deviation between fuel cell stacks caused by the imbalance between the sub-stacks.

If the temperature difference between the first sub-stack 100-1 and the second sub-stack 100-2 is less than or equal to the preset reference temperature difference, the controller 300 may control the direction of the magnetic field for both the first sub-stack 100-1 and the second sub-stack 100-2. The magnetic fields of the first sub-stack and the second sub-stack may be controlled in the same direction.

For example, if the temperature difference between the first sub-stack 100-1 and the second sub-stack 100-2 satisfies (e.g., is less than or equal to) the preset reference temperature difference, and the moisture state of the fuel cell stack 100 is in the dry-out state, the controller 300 may control the magnetic fields of both the first sub-stack 100-1 and the second sub-stack 100-2 to the second direction. Also, or alternatively, if the temperature difference between the first sub-stack 100-1 and the second sub-stack 100-2 satisfies (e.g., is less than or equal to) the preset reference temperature difference, and the moisture state of the fuel cell stack 100 is in the flooding state, the controller 300 may control the magnetic fields of both the first sub-stack 100-1 and the second sub-stack 100-2 to the first direction.

In controlling the magnetic fields based on the temperature difference between the sub-stacks as described herein, the controller 300 may determine the temperature difference between the first sub-stack 100-1 and the second sub-stack 100-2 based on the coolant temperature at the coolant outlet (e.g., where the coolant, having exchanged heat with the fuel cell stack 100, flows out). For example the detection results of the temperature sensors s1 and s2 provided in each sub-stack may be utilized (e.g., received by the controller 300 from the temperature sensors s1 and s2). For example, the coolant at the coolant outlet may achieve a thermal equilibrium with the sub-stack through heat exchange with the sub-stack, so the coolant at the coolant outlet may serve as an effective indicator of the sub-stack's temperature. However, the temperature difference between the sub-stacks may not necessarily be determined based on the coolant temperature at the coolant outlet in this way. The temperature difference between the sub-stacks may be determined based on the temperature of each sub-stack, which may be measured, determined, and/or estimated using various methods.

The controller 300 may perform either a determination of whether the flooding state is present and/or a determination of whether the dry-out state is present based on a comparison result of a voltage deviation between cells of the fuel cell stack 100 (e.g., relative to a preset reference voltage deviation). For example, the voltage deviation between cells may refer to a value obtained by subtracting the voltage of the fuel cell with the lowest voltage from the average cell voltage, which may be calculated by dividing the total stack voltage by the number of fuel cells. The reference voltage deviation may be set, for example, to 40 mV, but the specific value may vary/be varied depending on the specifications of the fuel cell system.

The controller 300 may determine whether the dry-out state is present based on the voltage deviation between cells satisfying (e.g., being less than or equal to) the preset reference voltage deviation. If it is determined that the dry-out state is not present, the controller may control the direction of the magnetic field to the second direction (e.g., to suppress the electrochemical reaction by lowering the voltage of the fuel cell.

Also, or alternatively, the controller 300 may determine whether the flooding state is present based on the voltage deviation between cells satisfying (e.g., exceeding and/or meeting) the preset reference voltage deviation. If it is determined that the flooding state is not present, the controller may maintain the current state of the magnetic field forming portion 200. For example, if the magnetic field is currently formed in the first direction, the magnetic field may be maintained in the first direction. If the magnetic field is not formed by the magnetic field forming portion 200, the state with no magnetic field may be maintained. Also, or alternatively, the controller 300 may maintain other operating conditions of the fuel cell (e.g., in addition to the state of the magnetic field forming portion 200). It may be seen that the voltage deviation between cells occurred due to causes other than the flooding state. Therefore, the controller 300 may determine other potential causes for the voltage deviation between cells, such as whether low-flow control is performed.

The controller 300 may also, or alternatively, consider the temperature of the fuel cell stack 100 to determine whether the dry-out state is present. For example, the temperature of the fuel cell stack 100 may refer to an average temperature of the entire fuel cell stack 100 and/or a temperature at a specific point (e.g., of a fuel cell of the stack, within the fuel cell stack 100, etc.), and/or may refer to the temperature of the coolant at the coolant outlet of the fuel cell stack 100.

For example, the controller 300 may maintain the current state of the magnetic field forming portion 200 based on the temperature of the fuel cell stack 100 satisfying (e.g., being lower than or equal to) a preset reference temperature. The controller may maintain other operating conditions of the fuel cell in addition, or alternatively, to the state of the magnetic field forming portion 200. For example, the reference temperature may be set through vehicle testing or similar procedures. For example, the reference temperature may be set to 75° C. The specific value of the reference temperature may vary depending on the specifications of the fuel cell system, for example.

The determination of whether the flooding state or dry-out state is present, as described herein, may be performed based on/by Electrochemical Impedance Spectroscopy (EIS).

For example, the determination of whether the dry-out state is present may be performed based on the value of the High Frequency Resistance (HFR) measured while a drain valve (e.g., which may be used to discharge water generated by the electrochemical reaction of the fuel cell to the outside) is in a closed state.

Also, or alternatively, the determination of whether the flooding state is present may be performed based on the values of Mid Frequency Resistance (MFR) and/or Low Frequency Resistance (LFR) measured while/if the drain valve (e.g., which may be used to discharge water generated by the electrochemical reaction of the fuel cell to the outside) is in a closed state.

The controller 300 may control not only the direction of the formed magnetic field, but also, or alternatively, the intensity of the magnetic field. The extent to which the electrochemical reaction and/or water discharge of the fuel cell are promoted or suppressed may be controlled according to the intensity control of the magnetic field. The controller 300 may consider the state of the fuel cell stack 100 in controlling the intensity of the magnetic field as described herein.

The controller 300 may control the intensity of the magnetic field based on a temperature difference between sub-stacks (e.g., if the fuel cell stack 100 is implemented to include a plurality of sub-stacks). For example, the controller 300 may control the magnetic field intensity to be relatively lower based on the temperature difference between the sub-stacks being small compared to the temperature difference being large. For example, the controller 300 may control the magnetic field to (e.g., gradually) decrease the intensity of the magnetic field as the temperatures between the sub-stacks become equal (approach each other). The controller may disable/stop the formation of the magnetic field once the temperatures between the sub-stacks become equal. The controller 300 may also, or alternatively, control the intensity of the magnetic field based on the voltage deviation between cells. For example, the controller 300 may control the magnetic field intensity to be relatively lower if the voltage deviation between cells is small, compared to when the voltage deviation between cells is large. For example, the controller 300 may control the magnetic field to (e.g., gradually) decrease the intensity of the magnetic field as the voltage deviation between cells is reduced (e.g., as the voltages approach each other). Once the voltage deviation between cells is eliminated, the controller 300 may stop/disable the formation of the magnetic field.

Also, or alternatively to the examples described above, the controller 300 may control the intensity of the magnetic field by considering the state of the fuel cell stack 100 in terms of promoting and suppressing the electrochemical reaction and water discharge of the fuel cell.

A control process performed by the controller 300 described above will be described below using a flowchart.

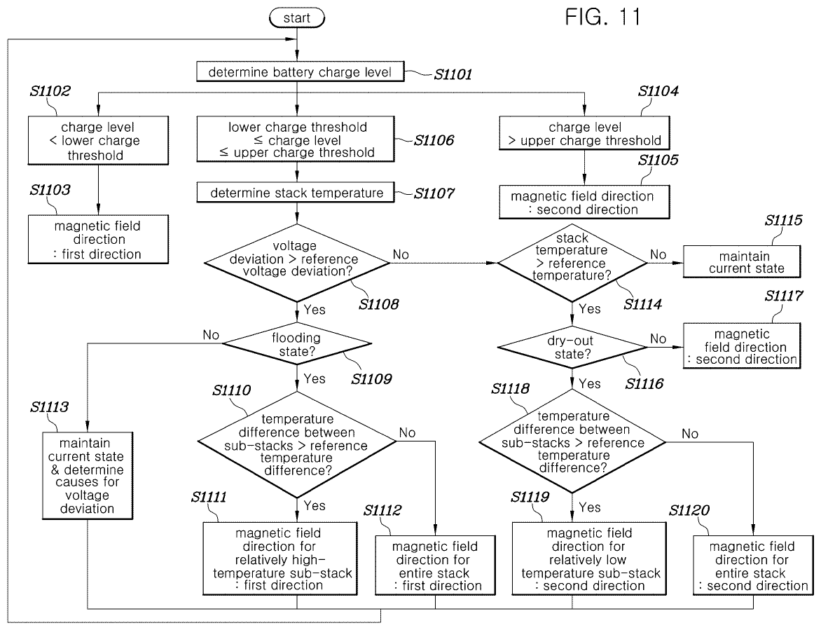

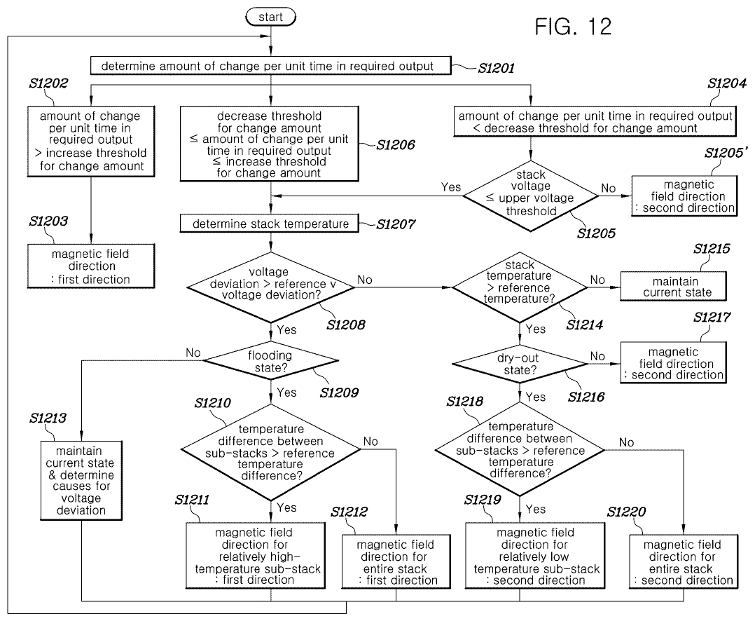

FIGS. 11 and 12 are flowcharts showing a control process of a fuel cell system performed by a controller according to an example of the present disclosure.

For convenience, FIGS. 11-12 are described by way of an example in which the steps are performed by a processor circuit. One, some, or all steps of the example methods of FIGS. 11-12 or portions thereof, may be performed by one or more other circuits. One or some, steps of the example methods of FIGS. 11-12 may be omitted, performed in other orders, and/or otherwise modified, and/or one or more additional steps may be added.

First, referring to FIG. 11, a flowchart of the magnetic field control based on the charge level of the battery 400 is shown. The controller 300 may determine the charge level of the battery 400 (S1101) before controlling the magnetic field formed through the magnetic field forming portion 200. For example, the controller 300 may receive a measure of the charge level of the battery 400 from a voltage and/or charge sensor associated with the battery 400. Based on the determined charge level of the battery 400, the controller 300 may control the magnetic field forming portion 200, to control a direction of the magnetic field formed in the fuel cell. For example, the step S1101 may be performed while the drain valve, which may be used to discharge water generated by the electrochemical reaction of the fuel cell to the outside, is in a closed state.

If the determined charge level of the battery 400 satisfies (e.g., is below or equal to) the preset lower charge threshold (S1102), the controller 300 may control the direction of the magnetic field, formed by/via the magnetic field forming portion 200, to the first direction (S1103) (e.g., to promote electrochemical reaction and water discharge, thereby reducing the overdischarge of the battery 400).

If the determined charge level of the battery 400 satisfies (e.g., exceeds) the preset upper charge threshold (S1104), the controller 300 may control the direction of the magnetic field, formed by/via the magnetic field forming portion 200, to the second direction (S1105) (e.g., to suppress electrochemical reaction and/or water discharge, thereby reducing the overcharge of the battery 400).

If the determined charge level of the battery 400 satisfies (e.g., is higher than or equal to the lower charge threshold) and does not satisfy (e.g., lower than or equal to the upper charge threshold (S1106), the controller 300 may determine the temperature of the fuel cell stack 100 (S1107) and/or control the magnetic field forming portion 200 based on the determined temperature of the fuel cell stack 100. For example, the temperature of the fuel cell stack 100 may be determined individually for each sub-stack.

The controller 300 may perform the determination of whether the flooding state or dry-out state is present, for example, based on the voltage deviation between cells (S1108). For example, if the voltage deviation between cells satisfies (e.g., exceeds or equals) the preset reference voltage deviation (Yes in S1108), the controller 300 may determine whether the flooding state is present (S1109). If it is determined that the flooding state is present (Yes in S1109), the controller may control the magnetic field on a sub-stack basis based on the temperature difference between the sub-stacks (S1110). If the temperature difference between the sub-stacks satisfies (e.g., exceeds or equals) the preset reference temperature difference (Yes in S1110), the controller may control the direction of the magnetic field to the first direction for the relatively high-temperature sub-stack (e.g., thereby preventing the worsening of the flooding state and eliminating the temperature difference between the sub-stacks) (S1111). If the temperature difference between the sub-stacks does not satisfy (e.g., is less than or equal to) the preset reference temperature difference (No in S1110), the controller may control the direction of the magnetic field to the first direction for the entire fuel cell stack 100, (e.g., thereby preventing the worsening of the flooding state) (S1112).

If the determination of the flooding state concludes that the flooding state is not present (No in S1109), the controller 300 may maintain the current state of the magnetic field forming portion 200 and/or determine other potential causes for the voltage deviation between cells (S1113).

If the voltage deviation between cells does not satisfy (e.g., is less than or equal to) the preset reference voltage deviation (No in S1108), the controller 300 may further consider the temperature of the fuel cell stack 100 to determine whether the dry-out state is present (S1114).

For example, if the temperature of the fuel cell stack 100 does not satisfy (e.g., is lower than or equal to) the preset reference temperature (No in S1114), the controller 300 may maintain the current state of the magnetic field forming portion 200 instead of determining whether the dry-out state is present (S1115).

On the other hand, if the temperature of the fuel cell stack 100 satisfies (e.g., exceeds) the preset reference temperature (Yes in S1114), the controller 300 may determine whether the dry-out state is present (S1116). For example, if it is determined that the dry-out state is not present (No in S1116), the controller 300 may control the direction of the magnetic field to the second direction for the entire fuel cell stack 100 to suppress the electrochemical reaction (S1117).

If it is determined that the dry-out state is present (Yes in S1116), the controller 300 may perform magnetic field control on a sub-stack basis based on the temperature difference between the sub-stacks (S1118). For example, if the temperature difference between the sub-stacks satisfies (e.g., exceeds) the preset reference temperature difference (Yes in S1118), the controller 300 may control the magnetic field direction of the relatively high-temperature sub-stack to the second direction (e.g., thereby preventing the worsening of the dry-out state and eliminating/reducing the temperature difference between the sub-stacks) (S1119). If the temperature difference between the sub-stacks does not satisfy (e.g., is less than or equal to) the preset reference temperature difference (No in S1118), the controller may control the magnetic field direction of the entire fuel cell stack 100 to the second direction (e.g., to prevent the worsening of the dry-out state) (S1120).

Magnetic field control based on the required output of the fuel cell stack 100 will be described below with reference to FIG. 12.

Referring to FIG. 12, the controller 300 may determine the amount of change per unit time in the required output (e.g., target power output) of the fuel cell stack 100 (S1201). The controller 300 may determine the amount of change, for example, before controlling the magnetic field formed through the magnetic field forming portion 200. Based on the determined amount of change per unit time in the required output of the fuel cell stack 100, the controller 300 may control the magnetic field forming portion 200, thereby controlling the direction of the magnetic field formed in the fuel cell.

If the determined amount of change per unit time in the required output satisfies (e.g., exceeds) the preset increase threshold for the change amount (S1202), the controller 300 controls the direction of the magnetic field, formed by/via the magnetic field forming portion 200, to the first direction (S1203), thereby promoting the electrochemical reaction and increasing the output of the fuel cell stack 100 in response to the increase in required output.

If the determined amount of change per unit time in the required output satisfies (e.g., is less than or equal to) the preset decrease threshold for the change amount (S1204), the controller 300 may control the direction of the magnetic field based on the voltage of the fuel cell stack 100 and an upper voltage threshold (S1205). For example, if the voltage of the fuel cell stack 100 does not satisfy (e.g., (exceeds) the upper voltage threshold (No in S1205), the controller 300 may control the direction of the magnetic field, formed through the magnetic field forming portion 200, to the second direction (S1205′) to suppress the electrochemical reaction. This may enable reducing the voltage of the fuel cell stack 100, thereby resolving the state of exceeding the upper voltage threshold.

If the voltage of the fuel cell stack 100 satisfies (e.g., is lower than or equal to) the upper voltage threshold (Yes in S1205) and/or the determined charge level of the battery 400 is higher than or equal to the lower charge threshold and lower than or equal to the upper charge threshold (S1206), the controller 300 may determine the temperature of the fuel cell stack 100 (S1207) and control the magnetic field forming portion 200 based on the determined temperature of the fuel cell stack 100. For example, the temperature of the fuel cell stack 100 may be determined individually for each sub-stack.

The controller 300 may perform the determination of whether the flooding state or dry-out state is present based on the voltage deviation between cells (S1208). For example, if the voltage deviation between cells satisfies (e.g., exceeds) the preset reference voltage deviation (Yes in S1208), the controller 300 may determine whether the flooding state is present (S1109). If the determination of the flooding state concludes that the flooding state is present (Yes in S1109), the controller may control the magnetic field on a sub-stack basis based on the temperature difference between the sub-stacks (S1210).

If the temperature difference between the sub-stacks satisfies (e.g., exceeds) the preset reference temperature difference (Yes in S1210), the controller may control the direction of the magnetic field to the first direction for the relatively high-temperature sub-stack, thereby preventing the worsening of the flooding state and eliminating the temperature difference between the sub-stacks (S1211).

If the temperature difference between the sub-stacks does not satisfy (e.g., is less than or equal to) the preset reference temperature difference (No in S1210), the controller may control the direction of the magnetic field to the first direction for the entire fuel cell stack 100, thereby preventing the worsening of the flooding state (S1212).

Furthermore, if the determination of the flooding state concludes that the flooding state is not present (No in S1209), the controller 300 may maintain the current state of the magnetic field forming portion 200 and determine other potential causes for the voltage deviation between cells (S1213).

If the voltage deviation between cells does not satisfy (e.g., is less than or equal to) the preset reference voltage deviation (No in S1208), the controller 300 may further consider the temperature of the fuel cell stack 100 to determine whether the dry-out state is present (S1214).

For example, if the temperature of the fuel cell stack 100 does not satisfy (e.g., is lower than or equal to) the preset reference temperature (No in S1214), the controller 300 may maintain the current state of the magnetic field forming portion 200 instead of determining whether the dry-out state is present (S1215).

On the other hand, if the temperature of the fuel cell stack 100 satisfies (e.g., exceeds) the preset reference temperature (Yes in S1214), the controller 300 may determine whether the dry-out state is present (S1216). For example, if it is determined that the dry-out state is not present (No in S1216), the controller 300 may control the direction of the magnetic field to the second direction for the entire fuel cell stack 100 to suppress the electrochemical reaction (S1217).

If it is determined that the dry-out state is present (Yes in S1216), the controller 300 may perform magnetic field control on a sub-stack basis based on the temperature difference between the sub-stacks (S1218). For example, if the temperature difference between the sub-stacks satisfies (e.g., exceeds) the preset reference temperature difference (Yes in S1218), the controller 300 may control the magnetic field direction of the relatively high-temperature sub-stack to the second direction, thereby preventing the worsening of the dry-out state and eliminating the temperature difference between the sub-stacks (S1219). If the temperature difference between the sub-stacks does not satisfy (e.g., is less than or equal to) the preset reference temperature difference (No in S1218), the controller may control the magnetic field direction of the entire fuel cell stack 100 to the second direction to prevent the worsening of the dry-out state (S1220).

FIGS. 11 and 12 show examples where the fuel cell system includes a plurality of sub-stacks, and individual control is performed on a sub-stack basis. However, referring to the descriptions in FIGS. 1 to 10, a fuel cell system according to another example may be configured to collectively control the magnetic field for a single stack or include a plurality of sub-stacks but control the magnetic field collectively for all sub-stacks. Furthermore, depending on examples, the magnetic field for a single stack or a plurality of sub-stacks may also be controlled by region through the individual control of a plurality of electromagnets.

An object of the present disclosure is to provide a fuel cell system capable of optimizing the operation of the fuel cell as needed in various situations, by controlling the electrochemical reactivity and water discharge capability of the fuel cell through a magnetic field.

The object of the present disclosure is not limited to the above-mentioned object, and the other objects which are not mentioned herein will be clearly understood from the following descriptions by those skilled in the art.

A fuel cell system according to an example of the present disclosure includes a fuel cell stack configured to include at least one fuel cell having an anode and a cathode, a magnetic field forming portion installed on the fuel cell stack and configured to variably form a magnetic field between the anode and cathode of at least one fuel cell, and a controller configured to selectively controls a direction of the magnetic field between a first direction, oriented from the cathode to the anode, and a second direction, oriented from the anode to the cathode when a magnetic field is formed by the magnetic field forming portion.

For example, the controller may control the direction of the magnetic field based on at least one of: a charge level of a battery connected to the fuel cell stack or a required output for the fuel cell stack.

For example, the controller may perform at least one of: promotion control, which controls the direction of the magnetic field to the first direction when the charge level of the battery is less than a preset lower charge threshold or suppression control, which controls the direction of the magnetic field to the second direction when the charge level of the battery exceeds a preset upper charge threshold.

For example, the controller may control the direction of the magnetic field based on a moisture state of the fuel cell stack, including a dry-out state and a flooding state, when the charge level of the battery is higher than or equal to the lower charge threshold and lower than or equal to the upper charge threshold.

For example, the controller may perform promotion control, which controls the direction of the magnetic field to the first direction when the amount of change per unit time in the required output for the fuel cell stack exceeds a preset increase threshold for the change amount (which is a positive value).

For example, the controller may control the direction of the magnetic field based on a stack voltage of the fuel cell stack and a preset upper voltage threshold when the amount of change per unit time in the required output for the fuel cell stack is below a preset decrease threshold for the change amount (which is a negative value).

For example, the controller may perform suppression control, which controls the direction of the magnetic field to the second direction when the stack voltage of the fuel cell stack exceeds the preset upper voltage threshold.

For example, the controller may control the direction of the magnetic field based on a moisture state of the fuel cell stack, including a flooding state and a dry-out state, when the stack voltage of the fuel cell stack is lower than or equal to the upper voltage threshold.

For example, the controller may control the direction of the magnetic field based on the moisture state of the fuel cell stack, including the flooding state and the dry-out state, when the amount of change per unit time in the required output for the fuel cell stack is less than or equal to the preset increase threshold for the change amount (which is a positive value) and more than or equal to the preset decrease threshold for the change amount (which is a negative value).

For example, the controller may perform at least one of: suppression control, which controls the direction of the magnetic field to the second direction when the moisture state of the fuel cell stack is in the dry-out state or promotion control, which controls the direction of the magnetic field to the first direction when the moisture state of the fuel cell stack is in the flooding state.

For example, the fuel cell stack may include a first sub-stack that includes parts of one or more fuel cells and a second sub-stack that includes the remaining parts of the fuel cells, the magnetic field forming portion may independently form a magnetic field for each fuel cell in the first sub-stack and the second sub-stack, and the controller may control the direction of the magnetic field for the first sub-stack and the second sub-stack based on a temperature difference between the first sub-stack and the second sub-stack.

The controller may control the direction of the magnetic field for either the first sub-stack or the second sub-stack when the temperature difference between the first sub-stack and the second sub-stack exceeds a preset reference temperature difference.

For example, the controller may perform suppression control, which controls the direction of the magnetic field to the second direction for a relatively low-temperature sub-stack between the first sub-stack and the second sub-stack when the temperature difference between the first sub-stack and the second sub-stack exceeds the preset reference temperature difference, and the moisture state of the fuel cell stack is in the dry-out state.

For example, the controller may perform promotion control, which controls the direction of the magnetic field to the first direction for a relatively high-temperature sub-stack between the first sub-stack and the second sub-stack when the temperature difference between the first sub-stack and the second sub-stack exceeds the preset reference temperature difference, and the moisture state of the fuel cell stack is in the flooding state.

For example, when the voltage deviation between cells of the fuel cell stack is lower than or equal to a preset reference deviation, the controller may determine whether the dry-out state is present, and perform suppression control, which controls the direction of the magnetic field to the second direction if it is determined that the dry-out state is not present.

For example, the controller may determine whether the dry-out state is present by further considering a temperature of the fuel cell stack and maintain the current state of the magnetic field forming portion when the temperature of the fuel cell stack is lower than or equal to a preset reference temperature.

For example, when the voltage deviation between cells of the fuel cell stack exceeds a preset reference deviation, the controller may determine whether the flooding state is present, and maintain the current state of the magnetic field forming portion if it is determined that the flooding state is not present.

For example, the controller may variably control the intensity of a magnetic field when the magnetic field is formed by the magnetic field forming portion.

For example, the fuel cell stack may include a first sub-stack that includes parts of one or more fuel cells and a second sub-stack that includes the remaining parts of the fuel cells, and the magnetic field forming portion may include a first electromagnet that forms a magnetic field for the first sub-stack, and a second electromagnet that forms a magnetic field for the second sub-stack.

For example, the magnetic field forming portion may include at least one electromagnet provided inside a fastening band that secures at least one fuel cell in a stacked state.

According to various examples of the present disclosure as described above, the electrochemical reactivity and water discharge capability of the fuel cell may be adjusted as needed through the magnetic field formed between the anode and cathode of the fuel cell, thereby enabling diversification of the operating strategies for the fuel cell.

Also, or alternatively, the various operating strategies described above enable the optimization of fuel cell operation according to the state of the fuel cell, control conditions, and operating environment.

The effects of the present disclosure are not limited to those mentioned herein. Other unmentioned effects and advantages will be clearly understood by those skilled in the art.

According to various examples of the present disclosure as described above, the electrochemical reactivity and water discharge capability of the fuel cell may be controlled as needed through the magnetic field formed between the anode and cathode of the fuel cell, thereby enabling diversification of the operating strategies for the fuel cell.

Also, or alternatively, the various operating strategies described above enable the optimization of fuel cell operation according to the state of the fuel cell, control conditions, and operating environment.

Although the specific examples of the present disclosure have been described and illustrated, those skilled in the art will appreciate that various alternations and modifications are possible without departing from the technical spirit of the present disclosure provided in the appended claims.

What is claimed is:

1. A fuel cell system, comprising:
a fuel cell stack comprising at least one fuel cell, wherein the at least one fuel cell comprises an anode and a cathode;
at least one electromagnet installed on the fuel cell stack and variably forms a magnetic field between the anode and the cathode; and
a controller circuit configured to selectively control, the electromagnet to form the magnetic field in a first direction, oriented from the cathode to the anode, or a second direction, oriented from the anode to the cathode.

2. The fuel cell system of claim 1, further comprising at least one sensor configured to determine at least one physical characteristic associated with the at least one fuel cell,
wherein the controller circuit configured to selectively control the at least one electromagnet based on the at least one physical characteristic, and
wherein the at least one physical characteristic comprises at least one of:
a charge level of a battery connected to the fuel cell stack, or
a target power output of the fuel cell stack.

3. The fuel cell system of claim 2, wherein the controller circuit is configured to:
selectively control the electromagnet to form the magnetic field in the first direction based on the charge level of the battery being less than a preset lower charge threshold, or
selectively control the electromagnet to form the magnetic field in the second direction based on the charge level of the battery exceeding a preset upper charge threshold.

4. The fuel cell system of claim 2, wherein the controller circuit is configured to selectively control, based on the charge level of the battery being higher than or equal to a lower charge threshold and lower than or equal to an upper charge threshold, the electromagnet to form the magnetic field based on a moisture state of the fuel cell stack, wherein the moisture state corresponds to a dry-out state or a flooding state.

5. The fuel cell system of claim 2, wherein the controller circuit is configured to control, based on a change amount per unit time in the target power output for the fuel cell stack exceeding a positive preset increase threshold for the change amount, the electromagnet to form the magnetic field in the first direction.

6. The fuel cell system of claim 2, wherein the controller circuit is configured to control, based on a change amount per unit time in the target power output for the fuel cell stack being below a negative preset decrease threshold for the change amount, the electromagnet to form the magnetic field in a direction that is based on a stack voltage of the fuel cell stack and a preset upper voltage threshold.

7. The fuel cell system of claim 6, wherein the controller circuit is configured to control the electromagnet to form the magnetic field in the second direction based on the stack voltage of the fuel cell stack exceeding the preset upper voltage threshold.

8. The fuel cell system of claim 6, wherein the controller circuit is configured to control the electromagnet to, based on the stack voltage of the fuel cell stack being lower than or equal to the preset upper voltage threshold, form the magnetic field in a direction that is based on a moisture state of the fuel cell stack, wherein the moisture state corresponds to a dry-out state or a flooding state.

9. The fuel cell system of claim 2, wherein the controller circuit is configured to, based on a change amount per unit time in the target power output for the fuel cell stack being less than or equal to a positive preset increase threshold for the change amount and greater than or equal to a negative preset decrease threshold for the change amount, control the electromagnet to form the magnetic field in a direction that is based on a moisture state of the fuel cell stack, wherein the moisture state corresponds to a flooding state or a dry-out state.

10. The fuel cell system of claim 1, wherein the controller circuit is configured to:
based on the fuel cell stack being in a dry-out state, control the electromagnet to form the magnetic field in the second direction, or
based on the fuel cell stack being in a flooding state, control the electromagnet to form the magnetic field in the first direction.

11. The fuel cell system of claim 1, wherein the fuel cell stack comprises a first sub-stack that comprises one or more first fuel cells and a second sub-stack that comprises one or more second fuel cells,
wherein the fuel cell system comprises a plurality of electromagnets, comprising the electromagnet, configured to independently form a first magnetic field for the first sub-stack and a second magnetic field for the second sub-stack, and
wherein the controller circuit is configured to control the plurality of electromagnets to form, based on a temperature difference between the first sub-stack and the second sub-stack, the first magnetic field for the first sub-stack or the second magnetic field for the second sub-stack.

12. The fuel cell system of claim 11, wherein the controller circuit is configured to control the plurality of electromagnets to form, based on the temperature difference between the first sub-stack and the second sub-stack exceeding a preset reference temperature difference, the first magnetic field for the first sub-stack or the second magnetic field for the second sub-stack.

13. The fuel cell system of claim 12, wherein the controller circuit is configured to control at least one electromagnet of the plurality of electromagnets to form, based on the first sub-stack having a lower temperature than the second sub-stack and the fuel cell stack being in a dry-out state, the first magnetic field in the second direction.

14. The fuel cell system of claim 12, wherein the controller circuit is configured to control the plurality of electromagnets to form, based on the first sub-stack having a higher temperature than the second sub-stack and based on the fuel cell stack being in a flooding state, the first magnetic field in the first direction.

15. The fuel cell system of claim 1, wherein the controller circuit is configured to:
determine, based a voltage deviation between cells of the fuel cell stack being less than or equal to a preset reference voltage deviation, a moisture state of the fuel cell stack; and
control the electromagnet to form the magnetic field in the second direction based on the determined moisture state not being a dry-out state.

16. The fuel cell system of claim 15, wherein the controller circuit is configured to:
based on a temperature of the fuel cell stack, determine whether the moisture state is in the dry-out state, and
based on the temperature of the fuel cell stack being lower than or equal to a preset reference temperature, maintain a current state of the electromagnet.

17. The fuel cell system of claim 1, wherein the controller circuit is configured to:
determine, based on a voltage deviation between cells of the fuel cell stack exceeding a preset reference voltage deviation, a moisture state of the fuel cell stack; and
based on the determined moisture state being a flooding state, maintain a current state of the electromagnet.

18. The fuel cell system of claim 1, wherein the controller circuit is further configured to variably control an intensity of the magnetic field.

19. A fuel cell system, comprising:
a fuel cell stack comprising at least one fuel cell, wherein the at least one fuel cell comprises an anode and a cathode;
an electromagnet configured to variably form a magnetic field between the anode and the cathode;
at least one sensor configured to determine at least one physical characteristic associated with the at least one fuel cell;
at least one processor; and
a memory storing at least one instruction that, when executed by the at least one processor, is configured to cause the fuel cell system to control, based on the at least one physical characteristic, the electromagnet to:
form the magnetic field in a changed direction, or
change an intensity of the magnetic field.

20. A method performed by an apparatus of a fuel cell system, the method comprising:
receiving, from at least one sensor of the fuel cell system, at least one physical characteristic of a fuel cell stack of the fuel cell system; and
controlling, based on the at least one physical characteristic, an electromagnet to form a magnetic field across a fuel cell of the fuel cell stack, wherein at least one of a direction of the magnetic field or an intensity of the magnetic field is set based on the at least one physical characteristic.
